(19) United States
(12) Patent Application Publication
(10) Pub. No.: US 2015/0265961 A1
(43) Pub. Date: Sep. 24, 2015

(54) System and Method for Particulate Matter Agglomeration

(71) Applicant: PEAK 3 PTY LTD, Brisbane, Queensland (AU)

(72) Inventors: Neil Paul Davey, Brisbane (AU); Alan Jonathon Ward, Brisbane (AU)

(73) Assignee: Peak 3 Pty Ltd., Loganholme DC, QLD (AU)

(21) Appl. No.: 14/440,865

(22) PCT Filed: Nov. 27, 2013
(86) PCT No.: PCT/AU2013/001373

§ 371 Date: May 5, 2015

(30) Foreign Application Priority Data
Nov. 28, 2012 (AU) 2012905209

(51) Int. Cl. B01D 51/08; F01N 3/033; B06B 1/06; B01D 50/00; B01J 19/10

(52) U.S. Cl. CPC B01D 51/08; B01D 50/00; B01J 19/10; B06B 1/06; F01N 3/033

(57) ABSTRACT

A particle matter agglomeration system (100) enables cost effective and efficient filtration of aerosols. The system (100) includes an acoustic chamber (110) for receiving an aerosol, and an ultrasonic transducer head assembly (300) for supporting an ultrasonic transducer (400). A transducer plate (410) faces into the acoustic chamber (110) for applying ultrasonic energy to the aerosol inside the acoustic chamber (110). A shaft (405) extends through the head assembly (300) and connects the transducer plate (410) to the ultrasonic transducer (400). A cooling jacket (315) is positioned around the shaft (405) and between the transducer plate (410) and the ultrasonic transducer (400), wherein the cooling jacket (315) receives cooling fluid for cooling the ultrasonic transducer (400).

### RELATED APPLICATIONS

The present application claims priority to International Patent Application Serial No. PCT/AU2013/001373, filed Nov. 27, 2013, which claims priority to Australian Patent Application Serial No. 2012905209, filed on Nov. 28, 2012, the entire disclosures of which are hereby expressly incorporated by reference herein.

### FIELD OF THE INVENTION

The present invention relates to particle agglomeration. In particular, although not exclusively, the invention relates to particle agglomeration in an aerosol stream using ultrasonic energy.

### BACKGROUND TO THE INVENTION

Exposure to diesel exhaust and diesel particulate matter (DPM) is a known hazard to humans. Diesel Emissions are classified by the International Agency for Research on Cancer as a Group 1 Carcinogen, in other words diesel particulate matter is known to be carcinogenic to humans.

Diesel powered engines are, however, very common in trucks, generators and heavy machinery. In many circumstances, environmental factors result in a localized increase in the concentration of diesel exhaust and DPM. This is especially the case for indoor and underground operations, such as in tunnels and underground mines.

Attempts have been made to filter diesel exhaust fumes and thus reduce the amount of DPM output in diesel exhaust fumes. Many systems of the prior art simply reduce the “smoke”, or larger particulate mass, and while appearing to be cleaner, the exhaust fumes still contain large amounts of DPM having small particle mass. Such systems therefore do not sufficiently decrease the health risks associated with diesel exhaust fumes.

Additionally, diesel exhaust filtration systems of the prior art are often based on mechanical filters, which are used to trap DPM particles. A problem with mechanical filters is that they become clogged and require replacement and/or cleaning at regular intervals.

There is therefore a need for an improved diesel exhaust filtration system.

### OBJECT OF THE INVENTION

It is an object of some embodiments of the present invention to provide consumers with improvements and advantages over the above described prior art, and/or overcome and alleviate one or more of the above described disadvantages of the prior art, and/or provide a useful commercial choice.

### SUMMARY OF THE INVENTION

According to a first aspect, the invention resides in a particle matter agglomeration system including:

an acoustic chamber for receiving an aerosol;

an ultrasonic transducer head assembly for supporting an ultrasonic transducer, the head assembly connected to the acoustic chamber;

a transducer plate facing into the acoustic chamber for applying ultrasonic energy to the aerosol inside the acoustic chamber;

a shaft connecting the transducer plate to the ultrasonic transducer; and

a cooling jacket positioned around the shaft and between the transducer plate and the ultrasonic transducer, the cooling jacket for receiving cooling fluid for cooling the ultrasonic transducer.

Preferably, walls of the ultrasonic transducer head assembly define the cooling jacket.

Preferably, the aerosol includes diesel exhaust fumes.

Preferably, the ultrasonic transducer comprises a piezoelectric transducer.

Preferably, the system includes a plurality of ultrasonic transducers, wherein each transducer in the plurality of ultrasonic transducers is for applying ultrasonic energy to the aerosol in the acoustic chamber.

Preferably, the cooling fluid includes at least one of water, glycol and air.

Preferably, the cooling fluid is recirculated in the system.

Preferably, the system includes a radiator connected to the cooling jacket for cooling the cooling fluid.

Preferably, O-rings applied around the transducer shaft define a seal of the cooling jacket.

Preferably, the transducer shaft is in direct contact with the cooling fluid.

Preferably, the acoustic chamber is elongate.

Preferably, the ultrasonic transducer is configured to operate in a direction perpendicular to the flow of gas through the acoustic chamber.

Preferably, the system includes an inertial flow separator connected to the acoustic chamber for separating the aerosol into a first stream and a second stream, wherein the first stream contains particles that are more fine than particles in the second stream, and wherein the first stream is processed in the acoustic chamber.

Preferably, the system includes a filter for removing agglomerated aerosol particles.

Preferably, the filter is a diesel particulate matter (DPM) removal device.

Preferably, the filter is a DPM catalyst or a diesel particulate filter.

Preferably, the system includes a control module connected to the ultrasonic transducer for controlling operation of the ultrasonic transducer.

Preferably, the control module comprises:

sensors for receiving a temperature of the aerosol and a feedback voltage from the ultrasonic transducer; and

a modulation module for supplying a modulation to the ultrasonic transducer, wherein the modulation is determined based upon input from the sensors.

Preferably, the modulation is a sine wave at a particular frequency.

Preferably, the control module further includes sensors for measuring at least one of: a density of the aerosol; a velocity of the aerosol; an intensity of an ultrasonic field in the acoustic chamber; a frequency of the ultrasonic energy in the acoustic chamber; an angle of an ultrasonic field in the acoustic chamber; and an amount of time the aerosol is exposed to the ultrasonic field.

### BRIEF DESCRIPTION OF THE DRAWINGS

To assist in understanding the invention and to enable a person skilled in the art to put the invention into practical effect, preferred embodiments of the invention are described below by way of example only with reference to the accompanying drawings, in which:

FIG. 1a illustrates a front perspective view of a particulate agglomeration system for an exhaust of a diesel engine, according to an embodiment of the present invention;

FIG. 1b illustrates a rear perspective view of the particle agglomeration system of FIG. 1;

FIG. 2a illustrates a front perspective view of an acoustic chamber of the particle agglomeration system of FIG. 1, according to an embodiment of the present invention;

FIG. 2b illustrates a top view of the acoustic chamber of FIG. 2a;

FIG. 2c illustrates a front view of the acoustic chamber of FIG. 2a;

FIG. 2d illustrates a side view of the acoustic chamber of FIG. 2a;

FIG. 3a illustrates a top left perspective view of a transducer head assembly of the particle agglomeration system of FIG. 1, according to an embodiment of the present invention;

FIG. 3b illustrates a top right perspective view of the transducer head assembly of FIG. 3a;

FIG. 3c illustrates a bottom right perspective view of the he transducer head assembly of FIG. 3a;

FIG. 3d illustrates a bottom view of the he transducer head assembly of FIG. 3a;

FIG. 3e illustrates a cross section of the transducer head assembly of FIG. 3a through axis A-A of FIG. 3d;

FIG. 4a illustrates a top left perspective view of a transducer head assembly of the particle agglomeration as shown in FIG. 3a, including the addition of a transducer, transducer plate and connecting shaft, according to an embodiment of the present invention;

FIG. 4b illustrates a top right perspective view of the transducer head assembly as shown in FIG. 3b, including the addition of a transducer, transducer plate and connecting shaft;

FIG. 4c illustrates a bottom right perspective view of the he transducer head assembly as shown in FIG. 3c, including the addition of a transducer, transducer plate and connecting shaft;

FIG. 4d illustrates a bottom view of the he transducer head assembly as shown in FIG. 3d, including the addition of a transducer, transducer plate and connecting shaft;

FIG. 4e illustrates a cross section of the transducer head assembly as shown in FIG. 3e, including the addition of a transducer, transducer plate and connecting shaft;

FIG. 5a illustrates an upper left perspective view of a control enclosure for the particulate agglomeration system of FIG. 1, according to an embodiment of the present invention;

FIG. 5b illustrates a lower left perspective view of the control enclosure of FIG. 5a;

FIG. 5c illustrates a side view of the control enclosure of FIG. 5a;

FIG. 5d illustrates a cross sectional view of the control enclosure of FIG. 5a through section B-B of FIG. 5c;

FIG. 6a illustrates a front perspective view of an inertial flow separator of the system of FIG. 1, according to an embodiment of the present invention;

FIG. 6b illustrates a front phantom view of the inertial flow separator of FIG. 6a;

FIG. 6c illustrates a side phantom view of the inertial flow separator of FIG. 6a; and

FIG. 6d illustrates a top phantom view of the inertial flow separator of FIG. 6a.

Those skilled in the art will appreciate that minor deviations from the layout of components as illustrated in the drawings will not detract from the proper functioning of the disclosed embodiments of the present invention.

### DETAILED DESCRIPTION OF THE INVENTION

Embodiments of the present invention comprise particle agglomeration systems and methods. Elements of the invention are illustrated in concise outline form in the drawings, showing only those specific details that are necessary to the understanding of the embodiments of the present invention, but so as not to clutter the disclosure with excessive detail that will be obvious to those of ordinary skill in the art in light of the present description.

In this patent specification, adjectives such as first and second, left and right, upper and lower, top and bottom, etc., are used solely to define one element or method step from another element or method step without necessarily requiring a specific relative position or sequence that is described by the adjectives. Words such as “comprises” or “includes” are not used to define an exclusive set of elements or method steps. Rather, such words merely define a minimum set of elements or method steps included in a particular embodiment of the present invention.

The reference to any prior art in this specification is not, and should not be taken as, an acknowledgement or any form of suggestion that the prior art forms part of the common general knowledge.

According to one aspect, the invention resides in a particle matter agglomeration system including: an acoustic chamber for receiving an aerosol; an ultrasonic transducer head assembly for supporting an ultrasonic transducer, the head assembly connected to the acoustic chamber; a transducer plate facing into the acoustic chamber for applying ultrasonic energy to the aerosol inside the acoustic chamber; a shaft connecting the transducer plate to the ultrasonic transducer; and a cooling jacket positioned around the shaft and between the transducer plate and the ultrasonic transducer, the cooling jacket for receiving cooling fluid for cooling the ultrasonic transducer.

Advantages of the present invention include cost effective and efficient filtration of aerosols, which in certain applications can increase personal safety for humans working in association with systems that generate such aerosols. According to certain embodiments, diesel machinery can be more safely operated in areas without good ventilation due to improved filtration of diesel particulate from the machinery.

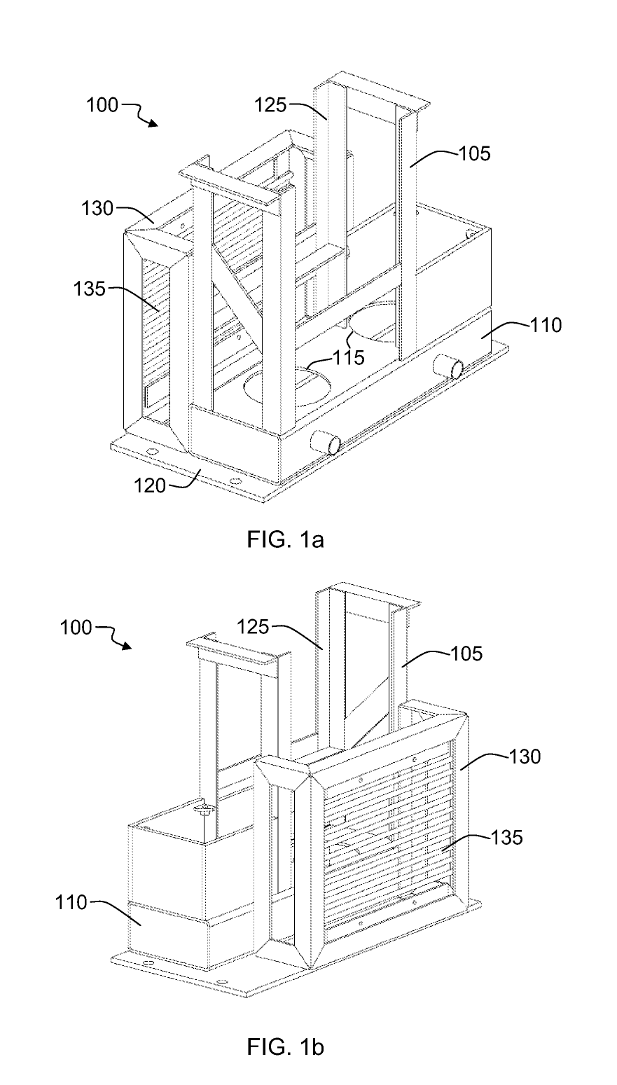

FIG. 1a illustrates a front perspective view of a particulate agglomeration system 100 for an exhaust of a diesel engine, according to an embodiment of the present invention. FIG. 1b illustrates a rear perspective view of the particle agglomeration system 100.

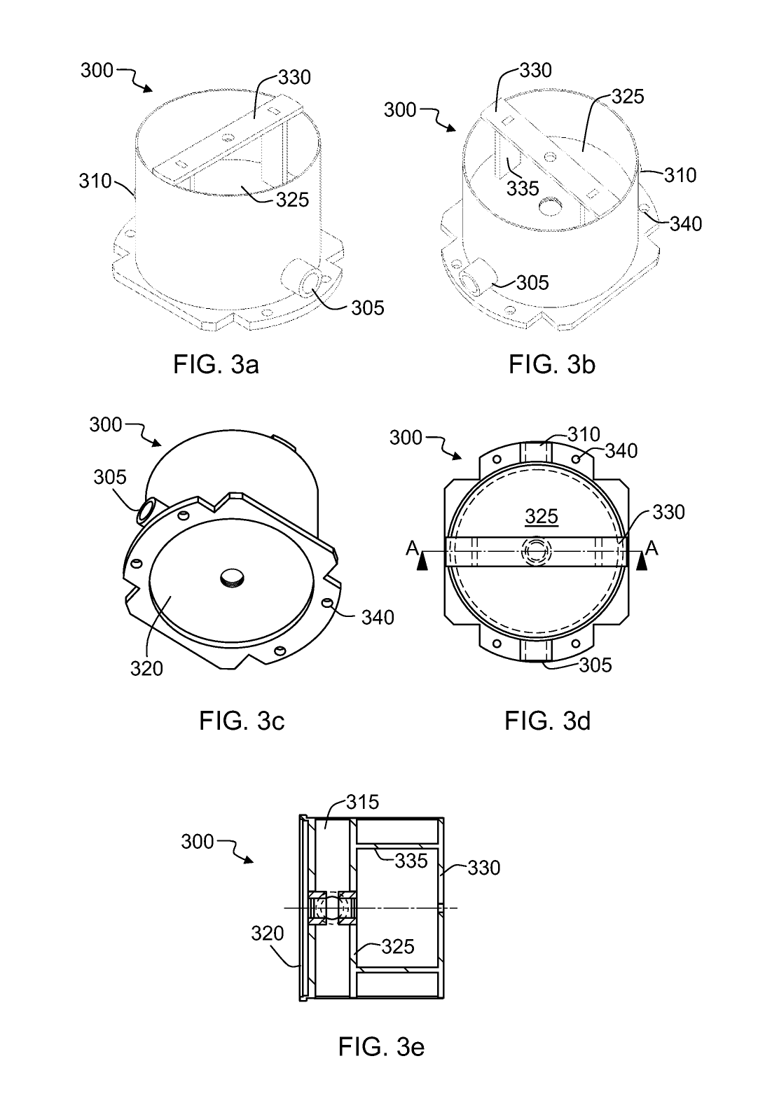

The particulate agglomeration system 100 includes a frame 105, an acoustic chamber 110 attached to the frame 105, and a plurality of transducer ports 115 in the acoustic chamber 110, each for receiving a transducer head assembly (not shown). The transducer head assemblies are described further below with reference to FIGS. 3a-3e. The transducer head assemblies are for receiving an ultrasonic transducer, such as a piezoelectric transducer, which are for applying ultrasonic energy to the acoustic chamber 110.

The frame 105 includes flanges 120, for mounting the particulate agglomeration system 100 in association with the diesel engine, and support channels 125 for receiving and supporting a control enclosure (not shown). The control enclosure is described in further detail below.

The particulate agglomeration system 100 further includes a radiator support 130, for supporting and protecting a radiator (not shown). The radiator support 130 includes a plurality of horizontal protective members 135, which are mounted in a spaced relationship to protect the radiator, without obstructing airflow to the radiator.

While the particulate agglomeration system 100 is described with reference to an exhaust of a diesel engine, the system 100 can be easily modified for use with any type of aerosol, including air or other gases that contain dust, paint particles or other fine particles.

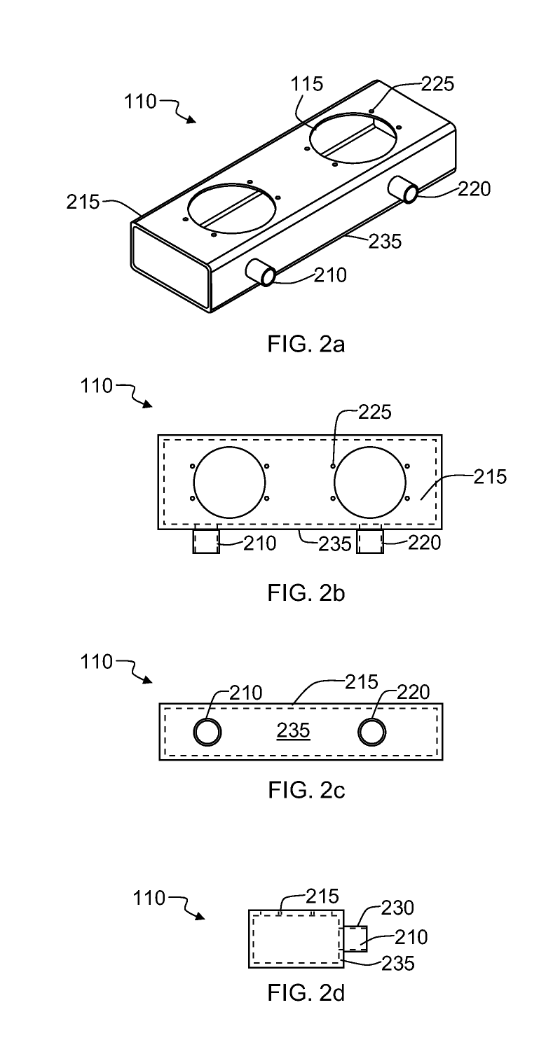

FIG. 2a illustrates a front perspective view of the acoustic chamber 110, according to an embodiment of the present invention. As discussed above, the acoustic chamber 110 includes transducer ports 115 for receiving the transducer head assemblies. The acoustic chamber 110 further includes an input port 210 connected to a housing 215, and an output port 220 connected to the housing 215.

FIG. 2b illustrates a top view of the acoustic chamber 110, FIG. 2c illustrates a front view of the acoustic chamber 110, and FIG. 2d illustrates a side view of the acoustic chamber 110, according to an embodiment of the present invention.

In association with each of the transducer ports 115 are mounting holes 225, for mounting the transducer head assemblies to the acoustic chamber 110. As will be readily understood by the skilled addressee, any suitable means can be used for mounting the transducer head assemblies to the acoustic chamber 110. The transducer head assemblies can, for example, be permanently attached to the acoustic chamber 110 by means of welding, be integrally formed with the acoustic chamber 110, or be bolted to the acoustic chamber 110.

The housing 215 is elongate in shape and the input port 210 and the output port 220 are located at respective ends of the housing 215. This forces fumes entering through the input port 210 to travel along the chamber 110, before exiting through the output port 220.

The transducer ports 115 are located along the housing 215 such that the transducer head assemblies can be installed for operation perpendicular to the flow of exhaust fumes. This enables high acoustic intensity across the entire exhaust flow, as the acoustic energy dissipates quickly with respect to distance traveled.

Two transducer ports 115 are illustrated, however a single transducer port 115 may be present, or more than two transducer ports 115 may be used. Several transducer ports 115 may be in series along the length of the housing 215, in parallel along a width of the housing 215 or form a combination thereof. Similarly, transducers connected to different transducer ports 115 can have identical operation, or be set to different frequencies or modulations.

The input port 210 and the output port 220 comprise flanges 230 that extend outwardly from a front wall 235 of the housing 215, and are for connection to exhaust pipes of the diesel engine. As will be readily understood by the skilled addressee, exhaust pipes can be connected to the input port 210 and the output port 220 by any suitable means.

According to certain embodiments, an inertial flow separator (not shown), described in further detail below, is located between the engine and the acoustic chamber 110. The inertial flow separator is used to direct diesel particulate matter (DPM) within a particular size range to the acoustic chamber 110. Preferably, the inertial flow separator directs particles less than 500 nm in diameter to the acoustic chamber 110. More preferably, the inertial flow separator directs particles less than 250 nm in diameter to the acoustic chamber 110. Particles of greater size need not be excluded from the stream, and are thus in some cases also permitted to enter the acoustic chamber 110, however the stream should comprise a significant number of particles less than 250 nm. The output port 220 is also connected to the inertial flow separator, and a pressure difference between the input and output ports 210, 220 causes the exhaust to flow through the acoustic chamber 110.

According to other embodiments, an inertial flow separator is not employed and the whole gas flow is sent to the acoustic chamber 110.

According to yet further alternative embodiments, the input port 210 and the output port 220 extend outwardly from opposite ends of the housing 215. Accordingly, the exhaust can flow along an entire length of the chamber 110.

In use, exhaust fumes enter the housing 215 from the input port 205, travel along the chamber 110, and exit through the output port 220. While in the chamber 110, the exhaust gases are treated by ultrasonic pressure waves from the ultrasonic transducer, thus causing particles of the exhaust gases to agglomerate.

Preferably, a diesel particulate matter catalyst, a diesel particulate filter or other DPM removal device (not shown) is located after the acoustic chamber 110. The DPM removal device is then used to filter the exhaust fumes and thus treat agglomerated particles for removal by a diesel oxidation catalyst (DOC), a diesel particulate filter (DPF) or similar device, prior to release of the fumes into the atmosphere.

FIG. 3a illustrates a top left perspective view of a transducer head assembly 300, according to an embodiment of the present invention. The transducer head assembly 300 is for receiving and supporting a piezoelectric transducer (not shown). The transducer head assembly 300 both supports and provides cooling for a shaft of the piezoelectric transducer.

The exhaust gas entering the acoustic chamber 110 is typically very hot, and in certain applications can be up to 600 degrees Celsius. Accordingly, a large amount of heat is transferred to the piezoelectric transducer. However, excessive heat affects the properties of piezoelectric transducers and can damage them. Accordingly, it is important to transfer heat from the piezoelectric transducer to ensure that it remains at an acceptable temperature.

FIG. 3b illustrates a top right perspective view, FIG. 3c illustrates a bottom right perspective view, FIG. 3d illustrates a bottom view, and FIG. 3e illustrates a cross section of the transducer head assembly 300 through axis A-A of FIG. 3d. The transducer head assembly 300 includes an inlet port 305 and an outlet port 310 for receiving and returning coolant, respectively. The coolant can be water, glycol, air or any other suitable coolant, and may be pumped through a radiator (not shown) or other similar device for cooling.

The inlet port 305 and the outlet port 310 are coupled to a coolant jacket 315, which is defined by and connected to the transducer head assembly 300. A shaft (not shown) of the piezoelectric transducer is in direct contact with the coolant jacket 315 and passes through a cavity defined by the coolant jacket 315. The shaft then passes through a centre hole in a lower support plate 320.

As coolant is pumped through the inlet port 305, into the coolant jacket 315, and out through the output port 310, heat is transferred from the shaft of the piezoelectric transducer to the coolant. The heat may then be dissipated from the coolant using a radiator, and recirculated again through the transducer head assembly 300. Accordingly, a reduced amount of heat is transferred from the acoustic chamber 110 to the piezoelectric transducer.

The transducer head assembly 300 comprises the lower support plate 320 defining a lower portion of the coolant jacket 315, and an upper support plate 325, for supporting the piezoelectric transducer and defining an upper portion of the coolant jacket 315. A transducer plate (not shown) can then be positioned adjacent to the lower support plate 320 without being in contact with the coolant. The transducer head assembly 300 then includes an upper support bar 330 and support arms 335 for supporting the piezoelectric transducer.

The piezoelectric transducer flexes with the application of voltage. A control module (not shown), discussed in further detail below, causes a modulated voltage to be applied to the piezoelectric transducer which in turn causes the piezoelectric transducer to vibrate at audible frequencies and ultrasonic frequencies. Vibration of the piezoelectric transducer is transferred to the transducer plate via a shaft of the piezoelectric transducer. The transducer plate then couples the acoustic energy/pressure field to the exhaust fumes.

An example of a suitable piezoelectric transducer is the A050020 transducer of Kinetic Ceramics, Hayward Calif.

When mounted to the acoustic chamber 110 with a transducer plate, the transducer plate forms an inner surface of the acoustic chamber 110 and is able to apply acoustic energy to the exhaust fumes.

The transducer head assembly 300 includes mounting holes 340, for securing the transducer head assembly 300 to the acoustic chamber 110, as discussed above.

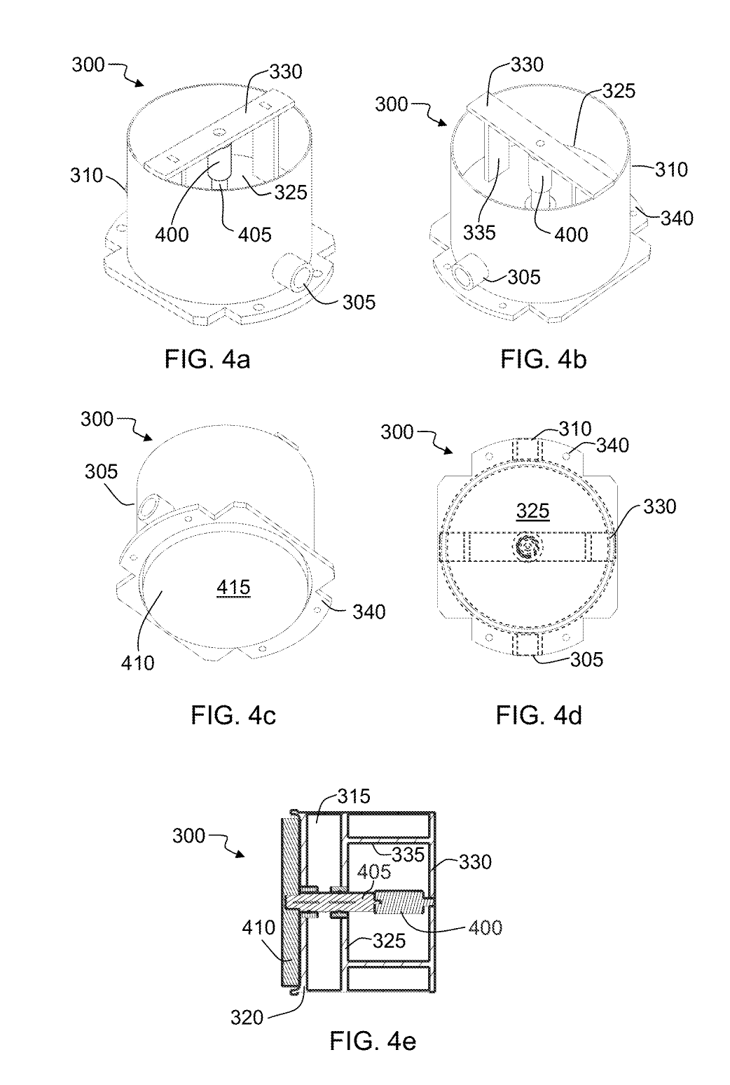

FIGS. 4a-4e correspond to FIGS. 3a-3e with the addition of an ultrasonic transducer 400, a transducer shaft 405, and a transducer plate 410 shown assembled with the transducer head assembly 300.

The transducer plate 410 includes a transducer surface 415, which forms an inner surface of the acoustic chamber 110 when assembled, and is used to apply acoustic energy to the exhaust gases inside the acoustic chamber 110. One surface of the transducer plate 410 includes a threaded hole for connecting the plate 410 to one end of the shaft 405. A second end of the shaft 405 is then secured to the transducer 400.

As will be understood by those having ordinary skill in the art, O-rings can be used to provide a seal against the surface of the shaft 405 to prevent coolant from leaking out of the coolant jacket 315. Coolant is then able to directly contact the shaft 405 and effectively cool the end of the shaft 405 that is connected to the transducer 400, thereby significantly reducing an amount of heat flowing from the acoustic chamber 110 to the transducer 400.

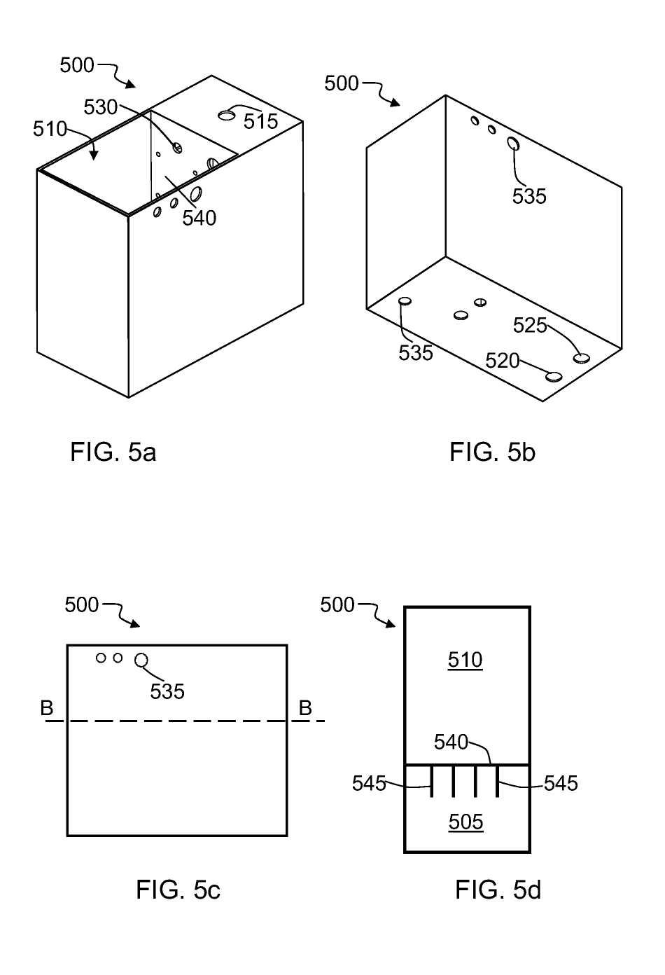

FIG. 5a illustrates an upper left perspective view of a control enclosure 500 for the particulate agglomeration system 100, according to an embodiment of the present invention. FIG. 5b illustrates a lower left perspective view, FIG. 5c illustrates a side view, and FIG. 5d illustrates a cross sectional view of the control enclosure 500 through section B-B of FIG. 5c.

The control enclosure 500 includes a reservoir tank 505 for storing coolant from where it is transported to the transducer head assembly 300, and back to the reservoir tank 505 via a radiator (not shown). This enables the coolant to transfer energy from the transducer head assembly 300 to the radiator for dissipation outside of the particulate agglomeration system 100. As will be readily understood by a person skilled in the art, the radiator can be cooled by ambient air or another fluid.

The control enclosure 500 includes an electronics enclosure 510, for enclosing and protecting electronics, amplifiers and a control module (not shown), for controlling the piezoelectric transducer and other components.

The control enclosure 500 includes a coolant filling point 515, for adding coolant to the reservoir tank 505, an inlet port 520 and an output port 525, the inlet port 520 for receiving coolant from the radiator and the output port 525 for sending coolant to the radiator. Thus, a coolant circuit is defined by the reservoir tank 505, radiator and any associated plumbing (not shown).

The control enclosure 500 further includes sensor ports 530 for coolant temperature sensors and coolant level sensors, and wiring ports 535, for allowing wiring to enter and leave the electronics enclosure 510.

The control module can include sensors (not shown) for receiving a temperature of the aerosol and a feedback voltage from the piezoelectric transducer. As the temperature of the aerosol changes, the resonance frequency of the piezoelectric transducer changes. By measuring the feedback voltage of the piezoelectric transducer, the control module can determine if the piezoelectric transducer is operating at its resonance frequency.

The control module can include other sensors for measuring a density of the aerosol, a velocity of the aerosol, an intensity of an ultrasonic field in the acoustic chamber, a frequency of the ultrasonic energy in the acoustic chamber, an angle of an ultrasonic field in the acoustic chamber, and an amount of time the aerosol is exposed to the ultrasonic field. These may also be considered by the control module when controlling components of the system 100.

The control module includes a modulation module, for supplying a modulation to the piezoelectric transducer. The modulation is determined based upon input from the sensors, and can, for example, comprise a sine wave at a particular frequency. By changing the frequency of the sine wave, the control module can ensure that the piezoelectric transducer is operating at its resonance frequency, even when environmental factors cause the resonance frequency of the piezoelectric transducer to vary.

The modulation from the control module is amplified by the amplifiers before being provided to the piezoelectric transducer.

The amplifiers are mounted to an aluminium plate, which is in turn mounted to an inner wall 540 of the control enclosure 500 with a layer of thermal transfer compound. This enables heat generated by the amplifiers to be dissipated through the inner wall 540 to the coolant of the reservoir tank 505. As shown in FIG. 5d, the control enclosure 500 further includes a plurality of heat sink elements 545, each of which extends from the inner wall 540 into the reservoir tank 505. The heat sink elements 545 enable heat from the amplifiers to be efficiently transferred from the inner wall 540 to coolant of the reservoir tank 505.

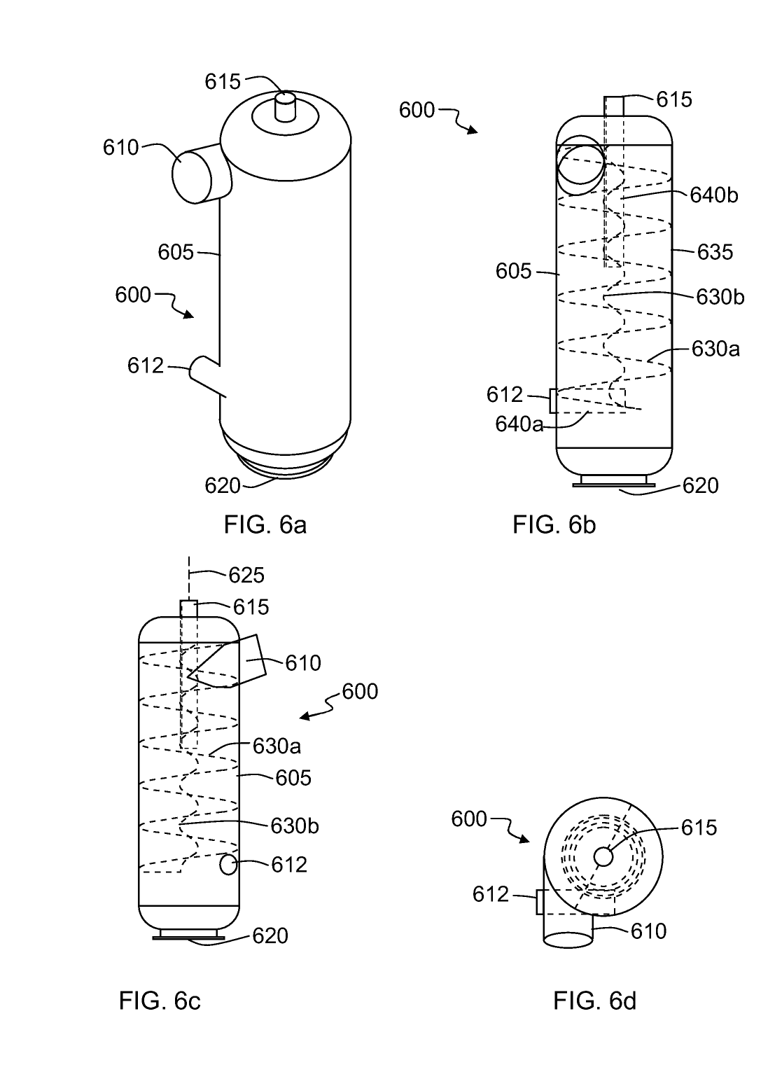

FIG. 6a illustrates a front perspective view of an inertial flow separator 600, according to an embodiment of the present invention.

According to certain embodiments, the exhaust gas is introduced to the inertial flow separator 600 before and/or after it is processed by the acoustic chamber 110. Prior to processing by the acoustic chamber 110, the exhaust gases can be processed by the inertial flow separator 600 in order to direct a high concentration of small particles into the acoustic chamber 110, while directly removing large particles. After processing by the acoustic chamber 110, the exhaust gases can be processed by the inertial flow separator 600 to remove the large particles created by agglomeration in the acoustic chamber 100.

FIG. 6b illustrates a front phantom view, FIG. 6c illustrates a side phantom view and FIG. 6d illustrates a top phantom view of the inertial flow separator 600.

The inertial flow separator 600 comprises a cylindrical main chamber 605, an exhaust inlet 610, a first stream output 612, a first stream return 615 and a second stream output 620.

The inertial flow separator 600 receives exhaust gases at the exhaust inlet 610, which then enters the cylindrical main chamber 605. The exhaust inlet 610 is located adjacent and parallel to an outer edge of the cylindrical main chamber 605 such that the exhaust gases are forced to spin around a primary axis 625 of the cylindrical main chamber 605, as illustrated by first and second notional particle paths 630a, 630b.

Large heavy particles, such as the particle agglomerations formed in the acoustic chamber 110, are centrifugally forced to an outer wall 635 of the cylindrical main chamber 605, as illustrated by the first notional path 630a. Smaller light particles remain in a central portion of the cylindrical main chamber 605, as illustrated by the second notional path 630b. The light particles form a first stream, extracted by the first stream output 612, and the heavy particles form a second stream, extracted by the second stream output 620.

This is achieved as the large heavy particles defining the second stream eventually settle at the second stream output, while the lighter particles of the first stream are removed by the first output 612 due to a pressure difference between the first stream output 612 and the first stream return 615.

The first stream output 612 is defined by a first pipe 640a, that extends into the cylindrical main chamber 605 parallel to the outer wall 635. The first stream return 615 is defined by a second pipe 640b that extends into the cylindrical main chamber 605 along the primary axis 625. The locations of the first and second pipes 640a, 640b in outer and inner portions of the cylindrical main chamber 605 provide the pressure difference discussed above. As discussed above, the inertial flow separator 600 is dimensioned such that a significant number of particles less than 250 nm form the first stream and are thus delivered into the acoustic chamber 110. Some particles greater than this are also permitted to enter the acoustic chamber 110; however a core function of the inertial flow separator 600 is to provide a concentrated stream of smaller particles to the acoustic chamber 110.

According to alternative embodiments (not shown), the output of the acoustic chamber 110 is mixed with new exhaust gases and thus introduced into the inertial flow separator 600 by the exhaust inlet 610.

In embodiments where the treated gas is returned to the inertial flow separator 600, certain particles that have not sufficiently agglomerated may be separated out again and passed into the acoustic chamber 110.

In summary, advantages of the present invention include cost effective and efficient filtration of aerosols, which in certain applications can increase personal safety for humans working in association with systems that generate such aerosols. According to certain embodiments, diesel machinery can be more safely operated in areas without good ventilation.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. Accordingly, this patent specification is intended to embrace all alternatives, modifications and variations of the present invention that have been discussed herein, and other embodiments that fall within the spirit and scope of the above described invention.

1. A particle matter agglomeration system, comprising:
an acoustic chamber for receiving an aerosol;
an ultrasonic transducer head assembly for supporting an ultrasonic transducer, the head assembly connected to the acoustic chamber;
a transducer plate facing into the acoustic chamber for applying ultrasonic energy to the aerosol inside the acoustic chamber;
a shaft connecting the transducer plate to the ultrasonic transducer; and
a cooling jacket positioned around the shaft and between the transducer plate and the ultrasonic transducer, the cooling jacket for receiving cooling fluid for cooling the ultrasonic transducer.

2. The system of claim 1, wherein walls of the ultrasonic transducer head assembly define the cooling jacket

3. The system of claim 1, wherein the aerosol includes diesel exhaust fumes.

4. The system of claim 1, wherein the ultrasonic transducer comprises a piezoelectric transducer.

5. The system of claim 1, further comprising a plurality of ultrasonic transducers, wherein each transducer in the plurality of ultrasonic transducers is for applying ultrasonic energy to the aerosol in the acoustic chamber.

6. The system of claim 1, wherein the cooling fluid includes at least one of water, glycol and air.

7. The system of claim 1, wherein the cooling fluid is recirculated in the system.

8. The system of claim 1, further comprising a radiator connected to the cooling jacket for cooling the cooling fluid.

9. The system of claim 1, wherein O-rings applied around the transducer shaft define a seal of the cooling jacket.

10. The system of claim 1, wherein the transducer shaft is in direct contact with the cooling fluid.

11. The system of claim 1, wherein the acoustic chamber is elongate.

12. The system of claim 1, wherein the ultrasonic transducer is configured to operate in a direction perpendicular to the flow of gas through the acoustic chamber.

13. The system of claim 1, further comprising an inertial flow separator connected to the acoustic chamber for separating the aerosol into a first stream and a second stream, wherein the first stream contains particles that are more fine than particles in the second stream, and wherein the first stream is processed in the acoustic chamber.

14. The system of claim 1, further comprising a filter for removing agglomerated aerosol particles.

15. The system of claim 14, wherein the filter is a diesel particulate matter (DPM) removal device.

16. The system of claim 14, wherein the filter is a DPM catalyst or a diesel particulate filter.

17. The system of claim 1, further comprising a control module connected to the ultrasonic transducer for controlling operation of the ultrasonic transducer.

18. The system of claim 17, wherein the control module comprises:
sensors for receiving a temperature of the aerosol and a feedback voltage from the ultrasonic transducer; and
a modulation module for supplying a modulation to the ultrasonic transducer, wherein the modulation is determined based upon input from the sensors.

19. The system of claim 18, wherein the modulation is a sine wave at a particular frequency.

20. The system of claim 17, wherein the control module further includes sensors for measuring at least one of: a density of the aerosol; a velocity of the aerosol; an intensity of an ultrasonic field in the acoustic chamber; a frequency of the ultrasonic energy in the acoustic chamber; an angle of an ultrasonic field in the acoustic chamber; and an amount of time the aerosol is exposed to the ultrasonic field.
